(19) United States
(12) Patent Application Publication
(10) Pub. No.: US 2002/0107741 A1
(43) Pub. Date: Aug. 8, 2002

(54) Method and apparatus for determining a price based on satisfaction

(76) Inventors: Edith H. Stern, Yorktown Heights, NY (US); Philip S. Yu, Chappaqua, NY (US); David P. Greene, Ossining, NY (US); Barry E. Willner, Briarcliff Manor, NY (US)

Correspondence Address: BUCKLEY, MASCHOFF, TALWALKAR, & ALLISON, 5 ELM STREET, NEW CANAAN, CT, 06840, US

(21) Appl. No.: 09/779,060

(22) Filed: Feb. 8, 2001

(51) Int. Cl. G06F 17/60

(52) U.S. Cl. 705/16

(57) ABSTRACT

An apparatus, system, method and computer product for determining a price based on buyer satisfaction includes detecting a response of a buyer to the item, evaluating the buyer's response to the item, and then determining a price of the item based on the buyer's response. In one embodiment, the response of the buyer is detected using a monitoring device which includes one or more biometric sensors adapted to sense one or more biological conditions of the buyer. In one embodiment, the buyer's response to the item is evaluated using a analysis device which converts the measured biological conditions of the buyer into data representative of a buyer's level of satisfaction. The price of the item, in one embodiment, is determined using the analysis device which compares the buyer's level of satisfaction with information regarding the price of the item. In one embodiment, the price of the item increases as the buyer's level of satisfaction increases.

### FIELD OF THE INVENTION

The present invention relates to sales methods and apparatus. More particularly, the present invention provides a mechanism by which item pricing may be varied based on buyer satisfaction.

### BACKGROUND OF THE INVENTION

Merchants frequently advertise their goods with satisfaction guarantees. Advertisements proclaim “Satisfaction guaranteed or your money back!” Some consumers may take advantage of the satisfaction guarantee and return goods if they are dissatisfied with them. Merchants, unfortunately, have no accurate way of verifying whether their customers have truly been satisfied (or, whether customers invoking the guarantee truly were dissatisfied). It would be desirable to provide a way for merchants and their customers to accurately assess whether customers were satisfied with goods or services of the merchant.

Merchants wish to increase their profitability. Customers typically will pay more for items with which they are very satisfied. It would be desirable to provide a mechanism by which merchants could variably price items based on the level of satisfaction that a customer receives from the item.

Advances in sensor technologies have led to the development of a wide variety of biological and physiological response sensors which are suitable for detecting human responses. A number of such devices are described in work performed in the Affective Computing labs at the Massachusetts Institute of Technologies.

It would be advantageous to provide an apparatus, method, system and computer program product which employs these sensors to allow merchants to variably price items based on the degree of satisfaction that a customer receives from an item.

### SUMMARY OF THE INVENTION

To alleviate the problems inherent in the prior art, and to provide an ability for merchants and their customers to accurately assess whether the customers were satisfied with goods or services of the merchant, to establish prices based on buyer satisfaction, and to selectively price items based on buyer satisfaction, embodiments of the present invention provide an apparatus, system, method and computer product for determining a price based on buyer satisfaction.

In one embodiment, a method for pricing an item includes detecting a response of a buyer to the item, evaluating the buyer's response to the item, and then determining a price of the item based on the buyer's response. The “buyer” may be one or more individuals or entities purchasing, renting, testing, or otherwise evaluating the item. In one embodiment, the response of the buyer is detected using a monitoring device which includes one or more biometric sensors adapted to sense one or more biological conditions of the buyer. In one embodiment, the buyer's response to the item is evaluated using an analysis device which converts the measured biological conditions of the buyer into data representative of a buyer's level of satisfaction. The price of the item, in one embodiment, is determined using the analysis device which compares the buyer's level of satisfaction with information regarding the price of the item. In one embodiment, the price of the item increases as the buyer's level of satisfaction increases.

According to one embodiment, the item is at least one of: a digital good; a consumable good; a condition affecting an environment of said buyer; and a service.

In other embodiments, the monitoring device senses a plurality of different biological conditions of the buyer, converts the sensed information into a plurality of digital signals which are transmitted to a analysis device for evaluation and use in establishing a price for the item.

According to embodiments of the present invention, a number of different biological conditions may be measured, including: a skin conductance; a heart rate; a blood volume; a blood alcohol content; a respiration rate; a respiration volume or content; an electrical activity of muscle; a facial expression; and a voice change.

With these and other advantages and features of the invention that will become hereinafter apparent, the nature of the invention may be more clearly understood by reference to the following detailed description of the invention, the appended claims and to the several drawings attached herein.

### BRIEF DESCRIPTION OF THE DRAWINGS

FIG. 1 is a block diagram of a system consistent with the present invention;

FIG. 2A is a block diagram of one embodiment of the monitoring device depicted in FIG. 1;

FIG. 2B is a block diagram of another embodiment of the monitoring device depicted in FIG. 1;

FIG. 2C is a block diagram of another embodiment of the monitoring device depicted in FIG. 1;

FIG. 2D is a block diagram of another embodiment of the monitoring device depicted in FIG. 1 in conjunction with an analysis device;

FIG. 3 is a block diagram of an embodiment of the analysis device depicted in FIG. 1; and

FIG. 4 is a flow diagram illustrating an exemplary process for determining a price based on a buyers satisfaction according to an embodiment of the present invention.

### DETAILED DESCRIPTION

Applicants have recognized that vendors of goods and services, as well as buyers or purchasers of goods and services, would benefit from an ability to determine a price of an item based on the buyer's satisfaction. Embodiments of the present invention facilitate such a price determination.

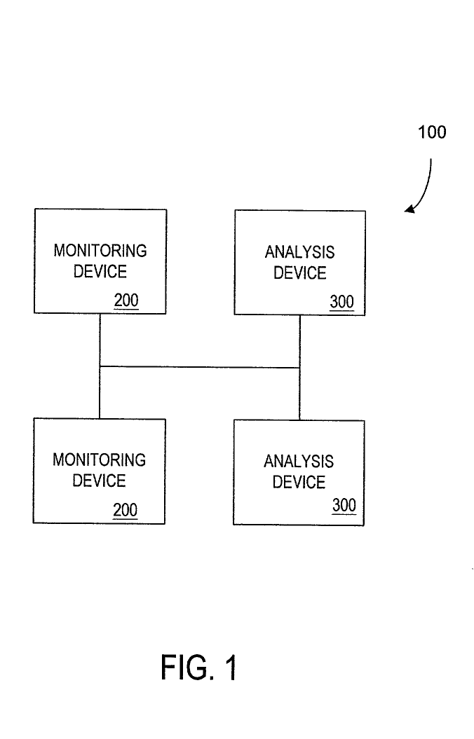

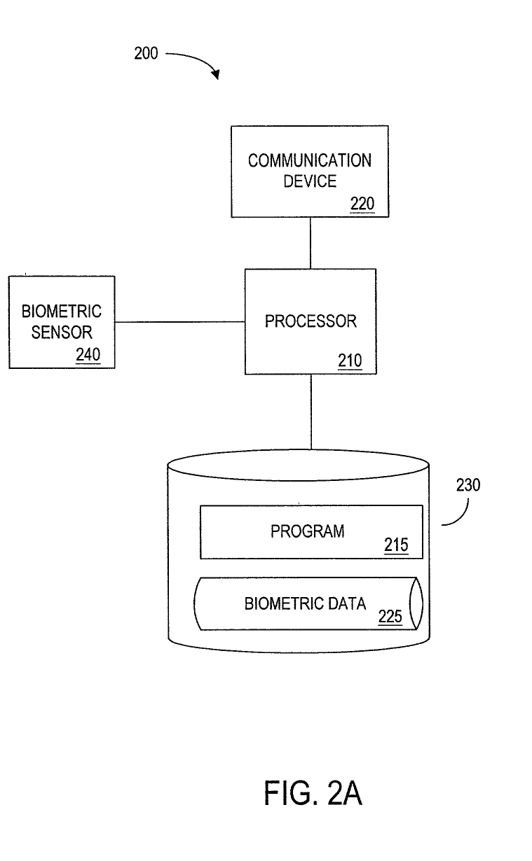

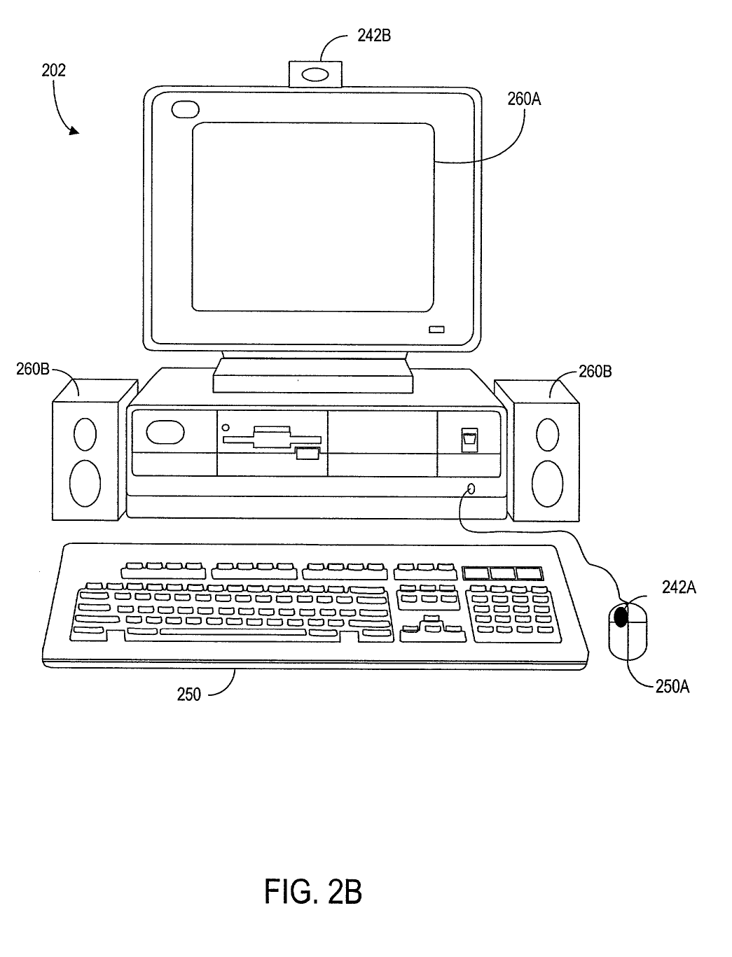

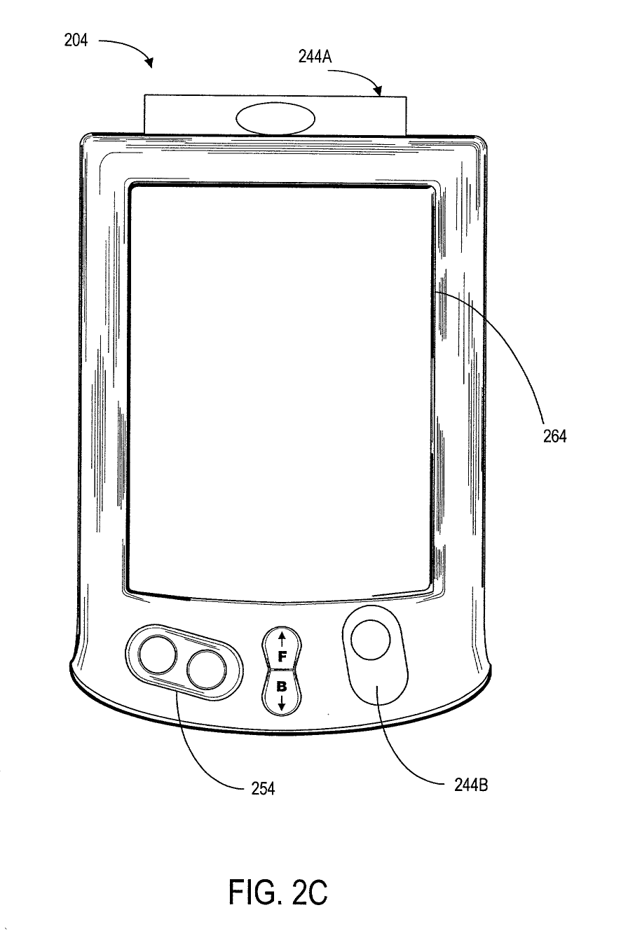

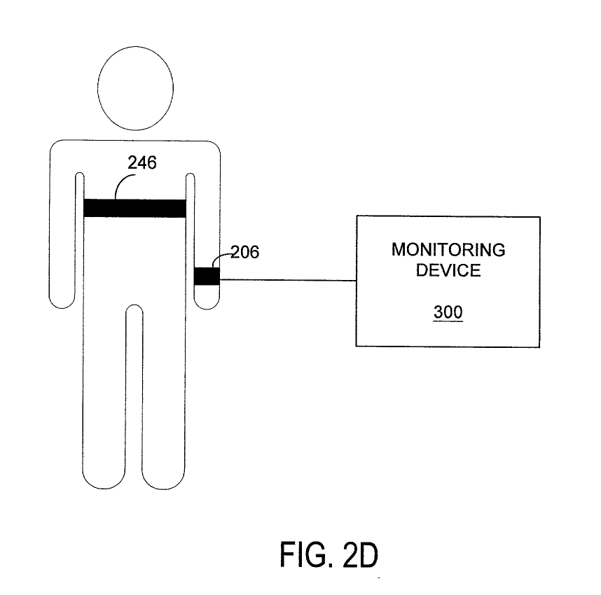

Throughout this disclosure, for simplicity and consistency, the term “buyer” is used to refer to an individual purchasing, leasing, renting, evaluating, testing, or otherwise receiving goods or services which are priced using embodiments of the present invention. In one embodiment, the “buyer” operates or interacts with a “monitoring device” (as shown and described in conjunction with FIGS. 1 and 2). The buyer need not actually purchase the item from the vendor, instead, he or she may simply be renting, leasing, or testing the item.

Further, the buyer need not be the individual purchasing, renting, leasing or testing the item, but may be cooperating with the individual who is. For example, a family may receive an offer of “We guarantee you will enjoy our pizza or your money back”. Each member of the family may operate a “monitoring device” to measure their individual satisfaction, but only one member of the family will actually pay for (or receive a rebate for) the pizza. Nevertheless, for the purposes of this disclosure, each family member operating a monitoring device may be referred to as a “buyer”.

The term “vendor” is used herein to refer to an entity selling, leasing, renting, or otherwise providing goods or services which are priced using embodiments of the present invention. Vendors evaluate, or analyze buyer satisfaction through use of an “analysis device” (as shown and described in conjunction with FIGS. 1 and 2). The vendor need not personally operate the analysis device, rather, one or more third parties may operate the analysis device on behalf of the vendor. The vendor may be a vendor of any of a number of types of goods or services. For example, a “vendor” may be a seller of electronic entertainment (e.g., a movie theater; a video store; an Internet-based music store; etc.), a restaurant or bar selling food or spirits, a utility (selling electricity, telephone service, gas, cable television, etc.), or any other entity which sells or leases goods or services.

The good or service being priced using techniques of the present invention will be generically referred to herein as the “item” to be priced. An “item” may include a number of different types of goods or services, including, for example: an environmental condition (e.g., the temperature of a hotel room); a digital good (e.g., a digital movie or song); a consumable good (e.g., a food item); a service (e.g., a car wash).

The term “satisfaction” is used to refer to an evaluated response of the buyer to the item. “Satisfaction” may include different response characteristics for different measured biological or physiological reactions and for different types of items. For example, where the item is a comedy movie, buyer satisfaction may be measured using a video camera which detects and analyzes the buyer's facial expressions. A large number of smiles may indicate satisfaction. Thus, a vendor of an item may define “satisfaction” in a number of different ways.

System

FIG. 1 is a block diagram of a sales system 100 according to one embodiment of the present invention. Sales system 100 includes a number of analysis devices 300 in communication with a number of monitoring devices 200. According to embodiments of the present invention, sales system 100 allows vendors of goods or services (referred to as “items” herein) to determine the price of the item based on a buyer's satisfaction with the item.

As will be described further below, vendors may measure a buyer's satisfaction by receiving information recorded by monitoring device 200 while the buyer is operating, consuming, or otherwise using the item. This information recorded by monitoring device 200 may include information describing a biological or physical response of the buyer to the item. This information is used by the vendor to determine a level of the buyer's satisfaction with the item. Using this information, the vendor may, for example, increase the price of the item (where the buyer had a high level of satisfaction from the item), accept a return of the item (where the buyer had a low level of satisfaction from the item), or otherwise vary the price of the item. The result is a system which allows vendors and purchasers of goods or services to price items in a manner which reflects the purchaser's level of satisfaction. Other benefits will also become apparent as further features are discussed below.

As used herein, devices (such as monitoring devices 200 and analysis devices 300) may communicate, for example, via a communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Moreover, as used herein, communications include those enabled by wired or wireless technology. Note that although two monitoring devices 200 and two analysis devices 300 are shown in FIG. 1, any number of monitoring or analysis devices 200, 300 may be included in the system 100. In some embodiments, monitoring devices 200 may communicate with each other. Similarly, analysis devices 300 may communicate with each other to share and exchange information.

In one embodiment of the present invention, a monitoring device 200 communicates with a remote, Web-based analysis device 300 (e.g., a server) via the Internet. Although some embodiments of the present invention are described with respect to information exchanged using a Web site, according to other embodiments information can instead be exchanged, for example, via: a telephone, an Interactive Voice Response Unit (IVRU), electronic mail, a WEBTV® interface, a cable network interface, and/or a wireless communication system.

Monitoring device 200 and analysis device 300 may be any devices capable of performing the various functions described herein. The devices may be, for example: a Personal Computer (PC), a portable computing device such as a Personal Digital Assistant (PDA), a wired or wireless telephone, a one-way or two-way pager, a kiosk, an interactive television device, a game terminal, or any other appropriate storage and/or communication device. As will be discussed in more detail below in conjunction with FIG. 2, monitoring device 200 preferably includes one or more sensors adapted to sense one or more biological or physiological reactions of the individual operating the device.

Note that the devices shown in FIG. 1 need not be in constant communication. For example, monitoring device 200 may only communicate with analysis device 300 via the Internet when appropriate (e.g., when attached to a “docking” station or “cradle” coupled to a buyer's PC). Monitoring device 200 may also communicate with analysis device 300 via an infrared device or wireless device when near a kiosk. Note also that a monitoring device 200 and an analysis device 300 may be incorporated in a single device (e.g., a vendor such as a restaurant may utilize a single device for each patron which acts as both a monitoring device 200 and an analysis device 300).

According to an embodiment of the present invention, a buyer operates or otherwise interacts with monitoring device 200 to first monitor and record his or her biological or physiological response to the item, and then to communicate with analysis device 300 to forward the recorded data to analysis analysis device 300. For example, a buyer may forward the data by coupling monitoring device 200 to his or her PC, direct a browser of the PC to access a Web site associated with analysis device 300, and then interact with analysis device 300 to forward data to analysis analysis device 300. Analysis device 300 may then manipulate and analyze the data to determine the buyer's level of satisfaction with the item and then take steps to determine a price of the item based on the buyer's level of satisfaction. In one embodiment, analysis device 300 may be operated on behalf of a number of different vendors. For example, analysis device 300 may be a Web-based server which collects and analyzes information from buyers of a number of different goods or services from different vendors (e.g., several video game manufacturers may use heart rate monitors to measure user excitement which may be analyzed using one or more shared analysis devices 300).

In one embodiment, analysis device 300 is operated by a third party who to generate satisfaction information which is then provided to the vendor for use in determining a price of the item.

Devices

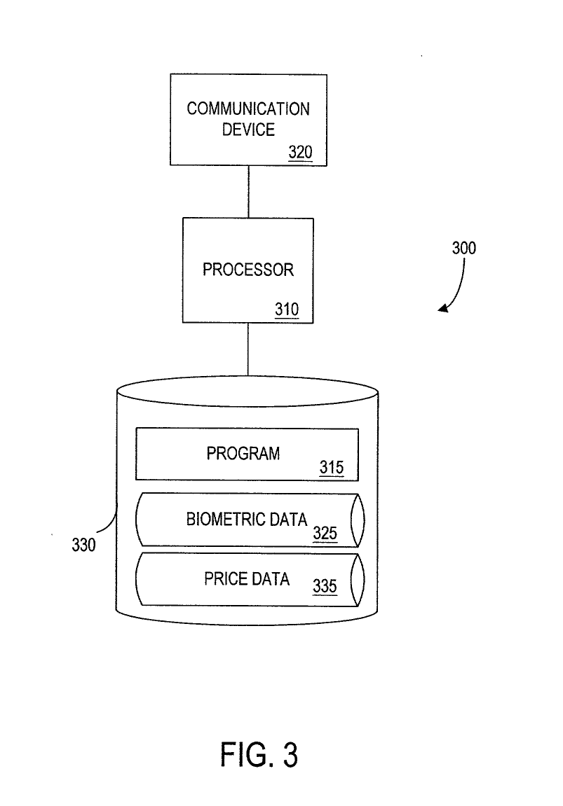

Each of the devices of FIG. 1 will now be described in more detail by referring to FIGS. 2 and 3.

1. Monitoring Device

FIG. 2A illustrates an embodiment of monitoring device 200. Monitoring device 200 may be implemented as a system controller, a dedicated hardware circuit, an appropriately programmed general purpose computer, or any other equivalent electronic, mechanical or electro-mechanical device. In some embodiments, monitoring device 200 is separate from the goods or services being priced. In other embodiments, monitoring device 200 is configured in the packaging or is a part of the goods or services being priced.

Monitoring device 200 comprises a processor 210, such as one or more Intel® Pentium® processors. Processor 210 is coupled to a communication port 220 through which the processor communicates with other devices, such as, for example, one or more analysis devices 300.

Processor 210 is in communication with a biometric sensor 240. Communication between processor 210 and biometric sensor 240 may be wired (e.g., via a communications bus) or wireless (e.g., via a radio-frequency or infra-red connection between a remote biometric sensor such as a heart rate monitor and a base station or receiving unit).

Biometric sensor 240 may be any of a number of different types of sensors used to monitor one or more measurable biological or physiological characteristics or responses of a buyer. For example, biometric sensor 240 may be a sensor designed to monitor specific characteristics. Biometric sensor 240 may be any of a variety of commercially available sensors, such as: a heart rate monitor, a galvanic skin response sensor, a blood volume pulse sensor, an electromyogram sensor, a respiration sensor, a blood alcohol sensor, a breath alcohol sensor, an odor response detector, etc. Biometric sensor 240 may also be a device such as a video camera adapted to monitor a buyer's facial expressions in conjunction with software designed to interpret those expressions. A large number of different biometric sensors 240 suitable for use in embodiments of the present invention are known to those skilled in the art, and need not be discussed in detail herein.

Biometric device 240 may also be formed from a microphone used in conjunction with voice recognition and analysis software, adapted to analyze a buyer's speech to detect information indicating a level of satisfaction. Biometric device 240 may also be a pressure sensitive device (e.g., a pressure pad formed on a computer mouse) adapted to detect variations in a buyer's pressure. The pressure sensitive device is used in conjunction with software adapted to analyze the variations in pressure to determine a buyer's level of satisfaction while operating the device.

Although a single biometric sensor 240 is shown in monitoring device 200, any number of biometric sensors 240 may be used in a single monitoring device 200. For example, referring now to FIG. 2B, monitoring device 202 includes several biometric sensors 242A and 242B. In the embodiment depicted in FIG. 2B, monitoring device 202 is a PC having a video camera functioning as sensor 242B, and a mouse with a pressure sensitive device functioning as sensor 242A. Measurements from one or both of these devices may be taken to ascertain a buyer's level of satisfaction when purchasing an item using monitoring device 202 (e.g., when the buyer is purchasing music over the Internet).

Other monitoring devices may also be configured with more than one sensor. Referring to FIG. 2C, a PDA is shown adapted to function as monitoring device 204. The PDA includes a video camera functioning as sensor 244A, and a pressure sensitive device function as sensor 244B. Again, measurements from one or both of these devices may be taken to ascertain a buyer's level of satisfaction when purchasing goods from a vendor.

Monitoring device 200 may be configured in other ways as well. For example, referring now to FIG. 2D, monitoring device 206 includes a separate sensor 246. In this example, monitoring device 206 is a heart rate monitor including a base portion formed to fit on a user's wrist and a separate heart rate sensor 246 formed to fit around the user's chest. Data sensed by sensor 246 is wirelessly transmitted to the base portion. Once heart rate data is recorded by monitoring device 206 it can then be transferred to analysis device 200 via a wired or wireless connection. In other embodiments, buyers may simply wear a transmitter device such as the heart rate sensor 246 which wirelessly transmits data to a analysis device for real time storage of data.

Referring again to FIG. 2A, processor 210 is also in communication with a data storage device 230. Data storage device 230 comprises an appropriate combination of magnetic, optical and/or semiconductor memory, and may include, for example, Random Access Memory (RAM), Read-Only Memory (ROM), a compact disk and/or a hard disk. Processor 210 and storage device 230 may each be, for example: (i) located entirely within a single computer or other computing device; or (ii) connected to each other by a remote communication medium, such as a serial port cable, telephone line or radio frequency transceiver.

In another embodiment, monitoring device 200 is operated in conjunction with another computing or transmission device to forward data and information to analysis device 300. For example, monitoring device 200 may be a small, portable biometric sensor such as a galvanic skin response sensor which is worn or carried by a buyer. The galvanic skin response sensor may store biometric data regarding the buyer, including information about the circumstances under which the data were stored (e.g., the date and time of sensing the data). This data may then be retrieved from the biometric sensor by coupling the sensor to a computing device, such as the buyer's PC, a kiosk, a analysis device 300, or the like. The data may then be forwarded to analysis device 300.

Data storage device 230 stores a program 215 for controlling the processor 210. Processor 210 performs instructions of program 215, and thereby operates in accordance with the present invention, and particularly in accordance with the methods described in detail herein. Program 215 may be stored in a compressed, uncompiled and/or encrypted format. Program 215 furthermore includes program elements that may be necessary, such as an operating system, a database management system and “device drivers” for allowing processor 210 to interface with computer peripheral devices. Appropriate program elements are known to those skilled in the art, and need not be described in detail herein.

According to an embodiment of the present invention, the instructions of program 215 may be read into a main memory from another computer-readable medium, such from a ROM to RAM. Execution of sequences of the instructions in program 215 causes processor 210 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Storage device 230 also stores biometric data 225, which includes data sensed by biometric sensor 240 while the buyer is operating, consuming, or otherwise using the item provided by the vendor. Those skilled in the art will recognize that a wide variety of other data may be stored by storage device 230, including time and date information and other information necessary or useful in the analysis of biometric data 225, such as information about the particular characteristics of the user of monitoring device 200 (e.g., age and health information which is useful in measuring the user's target heart rate).

2. Analysis Device

FIG. 3 illustrates an embodiment of analysis device 300. Analysis device 300 may be implemented as a system controller, a dedicated hardware circuit, an appropriately programmed general purpose computer, or any other equivalent electronic, mechanical or electro-mechanical device. A single analysis device 300 may receive information from one or more monitoring devices 200. Analysis device 300 may be operated by or on behalf of vendors pricing their goods or services using embodiments of the present invention.

Analysis device 300 comprises a processor 310, such as one or more Intel® Pentium® processors. Processor 310 is coupled to a communication port 320 through which the processor communicates with other devices, such as, for example, one or more monitoring devices 200.

Processor 310 is also in communication with a data storage device 330. Data storage device 330 comprises an appropriate combination of magnetic, optical and/or semiconductor memory, and may include, for example, Random Access Memory (RAM), Read-Only Memory (ROM), a compact disk and/or a hard disk. Processor 310 and storage device 330 may each be, for example: (i) located entirely within a single computer or other computing device; or (ii) connected to each other by a remote communication medium, such as a serial port cable, telephone line or radio frequency transceiver. In one embodiment, analysis device 300 may comprise one or more computers that are connected to a remote server computer for maintaining databases.

Data storage device 330 stores a program 315 for controlling the processor 310. Processor 310 performs instructions of program 315, and thereby operates in accordance with the present invention, and particularly in accordance with the methods described in detail herein. Program 315 may be stored in a compressed, uncompiled and/or encrypted format. Program 315 furthermore includes program elements that may be necessary, such as an operating system, a database management system and “device drivers” for allowing processor 310 to interface with computer peripheral devices. Appropriate program elements are known to those skilled in the art, and need not be described in detail herein.

According to an embodiment of the present invention, the instructions of program 315 may be read into a main memory from another computer-readable medium, such from a ROM to RAM. Execution of sequences of the instructions in program 315 causes processor 310 to perform the process steps described herein. In alternative embodiments, hard-wired circuitry may be used in place of, or in combination with, software instructions for implementation of the processes of the present invention. Thus, embodiments of the present invention are not limited to any specific combination of hardware and software.

Storage device 330 also stores data used by program 315, including biometric data 325 and price data 335. Biometric data 325 includes data received from monitoring device 200 and is used by program 315 to ascertain a buyer's level of satisfaction with the item provided by vendor. Price data 335 may include a base price of the item as well as price adjustment data for the item. For example, price data 335 may include pricing levels corresponding with various levels of satisfaction of buyers. Those skilled in the art will recognize that other data and programs may be stored by monitoring device 300 as well.

Process Description

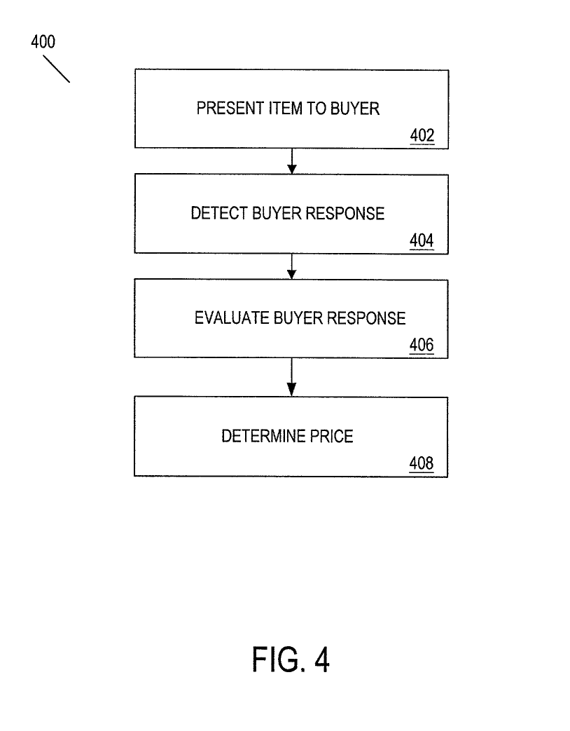

Referring to FIG. 4, a flow chart 400 represents a process of an embodiment of the present invention that may be performed by the system 100 (FIG. 1). The particular arrangement of elements in the flow chart of FIG. 4, as well as the other flow charts discussed herein, is not meant to imply a fixed order to the steps; embodiments of the present invention can be practiced in any order that is practicable.

Processing begins at 402 when an item is presented to a buyer by a vendor. As described above, the item presented can be any good or service. The vendor may present the item to the buyer physically (e.g., face to face at a brick and mortar retailer or service provider), or electronically (e.g., via the Internet, via Cable television, etc.) For the purposes of illustrating embodiments of the present invention, an example process will be described in conjunction with FIG. 4. In the example process, the buyer is a movie-goer, who has gone to a theater to watch a horror movie advertised as “The most frightening movie of the year!”. The theater (the “vendor”) may offer movie-goers (“buyers”) the guarantee “Receive half off your ticket price if you are not frightened by this movie.” in the example, processing at 402 may involve the buyer purchasing a movie ticket from the vendor, and receiving a monitoring device 200 (FIGS. 1 and 2) from the vendor. In this example, the monitoring device 200 is a heart rate monitor (such as the device depicted in FIG. 2D) which will be worn by the movie-goer as he watches the movie. The vendor need not provide the buyer with monitoring device 200. In some embodiments, the buyer may already possess a suitable monitoring device 200 which will facilitate monitoring of the buyer's response information. In other embodiments, such as the example being described, vendors will provide suitable monitoring devices 200 to buyers when the item is presented to the buyer at 402. In another example embodiment, monitoring device 200 may be attached to seats in the movie theater to monitor view responses as they watch the movie.

Processing continues at 404 where monitoring device 200 is operated to detect the buyer's response to the item. In the example, this will occur while the buyer views the horror movie. For example, the buyer may wear the heart rate monitor during the entire movie, or during select portions of the movie. In one embodiment, operation of monitoring device 200 is synchronized to the buyer's use of the item. In the example, operation of monitoring device 200 (the heart rate monitor) is synchronized with the movie so that the vendor can determine whether the buyer's heart rate increased during the time that the buyer was viewing the movie. As the buyer's response is being detected (e.g., by monitoring and measuring one or more biological responses of the buyer during the time that the buyer is operating, consuming, or otherwise using the item), the data is stored in monitoring device 200. In some embodiments, the data may be stored at analysis device 300.

Processing continues at 406, where the buyer's response is evaluated. In one embodiment, this evaluation occurs after the buyer is finished operating, consuming, or otherwise using the item. In the example, the evaluation may occur after the buyer finishes viewing the horror movie. In some embodiments, this processing may occur entirely under the control of monitoring device 200, e.g., through the use of software which is adapted to translate the biological responses of the buyer into some indication or representation of the buyer's satisfaction. In the example, the heart rate monitor may include software which translates an elevated heart rate into an indication of the buyer's level of fright while the buyer viewed the movie. This evaluation information may be conveyed to the vendor when the buyer returns the heart rate monitor to the ticket booth at the theater. In another embodiment, the evaluation information may be conveyed wirelessly to the vendor while the buyer watches the film (or at the end of the film).

In other embodiments, the evaluation of the buyer's response may occur entirely under the control of analysis device 300. For example, biological data from the monitoring device 200 may be transmitted to analysis device 300 after the buyer is done operating, consuming, or otherwise using the item. This transmission may occur in any of a number of ways, including, for example: by transferring removable magnetic media from monitoring device 200 to analysis device 300, by transferring file(s) via the Internet or any other communications network, by manual data entry into analysis device 300, etc. The evaluation of the buyer's response may then be accomplished by analysis device 300, using software which is adapted to translate the response data from the monitoring device 200 into satisfaction information.

In still other embodiments, the evaluation of the buyer's response may occur partially under the control of monitoring device 200 and partially under the control of analysis device 300. For example, monitoring device 200 may perform an initial assessment of the response data and analysis device 300 may perform a final evaluation of the data to generate buyer satisfaction data. Again, data may be transferred to analysis device 300 in any of a number of different ways.

Regardless of where the evaluation takes place, evaluation of the data is preferably performed by using techniques appropriate for the type of data sensed. For example, heart rate data received from monitoring device 200 may be evaluated using a program adapted to translate heart rate data into data indicating a level of fright (e.g., an elevated heart rate at certain points in the movie may indicate the movie-goer's level of fright). Evaluation may also take into account false inputs or insensitivities in construing buyer satisfaction. In the example, the theater may utilize software which measures a person's fright when viewing the movie. The software may assume that 90% of people who are frightened when watching a horror sequence have highly elevated heart rates. In evaluation at 406, the software may factor in the fact that some 10% of people who watch a horror sequence do not have a highly elevated heart rate. Other techniques may also be used to ensure that evaluation at 406 produces more accurate indications of a buyer's level of satisfaction.

Once the buyer's response to the item has been evaluated, processing continues at 408 where a price of the item is determined. This price determination may be accomplished in any of a number of ways. For example, the vendor may establish thresholds for item pricing based on various degrees of buyer satisfaction. The price of the item may increase if a buyer is very satisfied by the item. The price of the item may decrease if the buyer is very dissatisfied by the item. In the example being discussed in conjunction with FIG. 4, the theater offered “half off” if the movie-goer was not frightened by the movie. Thus, for the example, processing at 408 may involve giving the movie-goer a rebate if processing at 406 indicates that the movie-goer was not frightened.

In other embodiments, the price of the item may be determined by adding an amount to the price of the item based on the buyer's level of satisfaction. For example, a buyer renting a DVD movie may be charged an additional $1.00 over the base rental price of the DVD movie if it is determined the buyer was very satisfied with the movie. Similarly, an amount may be subtracted from a price of the item if the data indicates that the buyer was very dissatisfied by the item.

Other pricing schemes may also be used according to embodiments of the present invention, allowing vendors and buyers to arrive at prices of items based on the buyer's measured levels of satisfaction with the item. For example, in some embodiments, determining a price at 408 may be accomplished using buyer responses from more than one buyer.

Although the present invention has been described with respect to a preferred embodiment thereof, those skilled in the art will note that various substitutions may be made to those embodiments described herein without departing from the spirit and scope of the present invention.

What is claimed is:

1. A method for pricing an item, comprising:
obtaining a response of a buyer to said item; and
determining, based on said response, a level of satisfaction of said buyer with said item.

2. The method of claim 1, wherein said obtaining further comprises:
detecting a response of a buyer to said item; and
evaluating said response to generate buyer satisfaction information.

3. The method of claim 1, further comprising:
determining a price of said item based on said level of satisfaction.

4. The method of claim 3, wherein said determining a price is performed by a vendor of said item.

5. The method of claim 3, wherein said determining a price is performed by an agent of a vendor of said item.

6. The method of claim 1, wherein said item is at least one of: a digital good; a consumable good; a condition affecting an environment of said buyer; and a service.

7. The method of claim 2, wherein said detecting comprises:
sensing a biological condition of said buyer; and
converting said biological condition into a digital signal.

8. The method of claim 2, wherein said detecting comprises:
sensing a plurality of biological conditions of said buyer; and
converting each of said plurality of biological conditions of said buyer into a plurality of digital signals.

9. The method of claim 7, wherein said biological condition comprises at least one of: a skin conductance; a heart rate; a blood volume; a blood alcohol content; a respiration rate; a respiration volume or content; an electrical activity of muscle; a facial expression; and a voice change.

10. The method of claim 8, wherein said plurality of biological conditions comprise at least one of: a skin conductance; a heart rate; a blood volume; a blood alcohol content; a respiration rate; a respiration volume or content; an electrical activity of muscle; a facial expression; an odor response; and a voice change.

11. The method of claim 7, wherein said sensing is performed using at least one of: a galvanic skin response sensor; a heart rate monitor; a blood volume pulse sensor; a respiration sensor; a breath alcohol sensor; a blood alcohol sensor; an electromyogram sensor; a video capture device; an odor response sensor; and a voice analysis device.

12. The method of claim 1, wherein said determining comprises:
determining whether said response of said buyer is greater than a threshold amount.

13. The method of claim 1, wherein said determining comprises:
determining a magnitude of said response.

14. The method of claim 12, further comprising determining a price for said item, comprising:
increasing a price of said item from a base price if said response exceeds said threshold amount.

15. The method of claim 12, further comprising determining a price for said item, comprising:
decreasing a price of said item from a base price if said response is less than said threshold amount.

16. The method of claim 13, further comprising determining a price for said item, comprising:
selecting a price of said item based on said magnitude of said response.

17. The method of claim 3, further comprising:
detecting a response of a second buyer to said item;
evaluating said response of said second buyer; and
wherein said determining a price further comprises determining a price of said item based on said response of said buyer and said response of said second buyer.

18. An apparatus for pricing an item, comprising:
a first interface for obtaining biological data indicating a buyers response to said item; and
a computing device for determining, based on said buyers response, a level of satisfaction of said buyer with said item.

19. The apparatus of claim 18, wherein said computing device is further for:
determining a price of said item based on said level of satisfaction.

20. The apparatus of claim 18, wherein said biological data includes data identifying at least one of: a skin conductance; a heart rate; a blood volume; a blood alcohol content; a respiration rate; a respiration volume or content; an electrical activity of muscle; a facial expression; an odor response; and a voice change.

21. The apparatus of claim 18, wherein said determining further comprises:
determining whether said level of satisfaction is greater than a threshold amount.

22. The apparatus of claim 18, wherein said determining comprises:
determining a magnitude of said level of satisfaction.

23. The apparatus of claim 19, wherein said determining a price comprises:
increasing said price from a base price if said level of satisfaction exceeds a threshold amount.

24. The apparatus of claim 19, wherein said determining a price comprises:
selecting said price based on a magnitude of said level of satisfaction.

25. The apparatus of claim 19, said computing device further comprising:
detecting a level of satisfaction of a second buyer to said item;
evaluating said level of satisfaction of said second buyer; and
wherein said determining a price further comprises determining a price of said item based on said level of satisfaction of said buyer and said level of satisfaction of said second buyer.

26. The apparatus of claim 19, wherein the interface is a wireless interface.

27. The apparatus of claim 19, wherein the interface is a network connection.

28. A computer program product in a computer readable medium for determining a price of an item, comprising:
first instructions for obtaining biological data indicating a buyers response to said item; and
second instructions for determining, based on said buyers response, a level of satisfaction of said buyer with said item.

29. The computer program product of claim 28, further comprising:
third instructions for determining a price of said item based on said level of satisfaction.

30. The computer program product of claim 28, wherein said evaluating comprises:
fourth instructions for determining whether said response is greater than a threshold amount.

31. The computer program product of claim 28, wherein said evaluating comprises:
fifth instructions for determining a magnitude of said response.

32. The computer program product of claim 30, wherein said determining a price comprises:
sixth instructions for increasing said price from a base price if said response exceeds said threshold amount.

33. The computer program product of claim 31, wherein said determining a price comprises:
seventh instructions for selecting said price based on said magnitude of said response.
